(19) United States
(12) Patent Application Publication
(10) Pub. No.: US 2018/0013330 A1
(43) Pub. Date: Jan. 11, 2018

(54) Electrically Powered Generator

(71) Applicant: Justin Wei Hsin Fang, New Taipei City (TW)

(72) Inventor: Justin Wei Hsin Fang, New Taipei City (TW)

(21) Appl. No.: 15/202,046

(22) Filed: Jul. 5, 2016

(51) Int. Cl. H02K 7/02; H02K 7/08; H02K 47/00; H02K 7/116; H02K 53/00

(52) U.S. Cl. CPC H02K 7/025; H02K 47/00; H02K 7/116; H02K 7/08; H02K 53/00; Y10S 74/09

(57) ABSTRACT

An electrically powered generator includes an electric motor as a power source having an output rotational speed of 5000 rpm, and a transmission mechanism driven by the electric motor to operate and having rotors and stators connected to a rear end thereof for producing and outputting induced electric energy. The rotors have a rotational speed ranged between 290 and 300 rpm. The transmission mechanism includes a drive shaft driven by the electric motor to rotate and in turn bringing a transmission shaft, an auxiliary power shaft and first and second power output shafts to rotate through power transmission. First and second flywheels are mounted on the drive shaft and the auxiliary power shaft, respectively, to store potential energy. At the time the electric motor stops rotating, the flywheels, due to the rotational inertia thereof, convert the stored potential energy into kinetic energy for the transmission mechanism to operate continuously.

### FIELD OF THE INVENTION

The present invention relates to an electrically powered generator, which uses an electric motor as a power source and includes flywheels to store potential energy to enable increased transmission mechanism operating efficiency and upgraded kinetic-to-electric energy conversion efficiency of the generator.

### BACKGROUND OF THE INVENTION

An electric generator is a device that converts kinetic energy into electric energy. The power source of the electric generator can be wind, water, fossil fuel, or an internal combustion engine. These power sources can drive rotors of the electric generator to rotate and accordingly convert kinetic energy into electric energy for output.

Electric generators using wind, water or fossil fuel as the power source are usually bulk in volume and there are many restrictions on the places for installing large-scale electric generators. Further, the large-scale electric generators are immobile once they are installed.

Generally, in the places that require interruptible power supply, such as hospitals, telecommunication control rooms, data centers and important national defense facilities, a plurality of electric generators must be provided. Among others, mobile electric generators are prerequisite facilities for mobile support to power outage areas. Most of the currently available mobile electric generators are diesel engine generators and gasoline engine generators. During operation thereof, diesel and gasoline engine generators would produce toxic waste gases, which not only cause environmental pollution, but also endanger human health.

### SUMMARY OF THE INVENTION

A primary object of the present invention is to provide an electrically powered generator, which uses an electric motor as a power source to drive a transmission mechanism to operate. The transmission mechanism includes flywheels to store potential energy and accordingly enables increased transmission mechanism operating efficiency and upgraded kinetic-to-electric energy conversion efficiency of the generator.

Another object of the present invention is to provide an electrically powered generator, which does not produce waste gases during operation and is therefore environmentally friendly.

The electrically powered generator provided according to the present invention uses an electric motor as its power source. The electric motor drives a transmission mechanism to operate. With rotors and stators connected to a rear end of the transmission mechanism, the transmission mechanism in operation is able to rotate the rotors and enables the stators to produce and output induced electric energy. The electric motor has an output rotational speed of 5000 rpm, and the rotors have a rotational speed of 290-300 rpm.

The transmission mechanism includes a drive shaft, a transmission shaft, an auxiliary power shaft, a first power output shaft and a second power output shaft. The drive shaft is driven by the electric motor to rotate and transmits a rotational power to the transmission shaft for the latter to rotate. The transmission shaft in turn transmits a rotational power to the auxiliary power shaft and the first and second power output shafts at the same time. A first rotor is mounted on the first power output shaft and a second rotor is mounted on the second power output shaft. When the rotors rotate, the stators produce induced electric currents.

The drive shaft has a unidirectional transmission gear, a first flywheel and a first power output gear mounted thereon. The unidirectional transmission gear is driven by the electric motor to rotate. A unidirectional transmission bearing is mounted between the unidirectional transmission gear and the drive shaft, such that the drive shaft could not bring the unidirectional transmission gear to rotate. The electric motor stops operating when the drive shaft reaches a rotational speed of 2500 rpm.

The transmission shaft has a reduction gear and a transmission gear fixedly mounted thereon; and the reduction gear meshes with the first power output gear mounted on the drive shaft. The auxiliary power shaft has a second flywheel and a second power output gear fixedly mounted thereon. The second power output gear meshes with the reduction gear mounted on the transmission shaft and rotate synchronously with the drive shaft. The auxiliary power shaft and the drive shaft are bilaterally symmetrically located at two lateral sides of the transmission shaft.

The first and the second flywheel can store potential energy. At the time the electric motor stops rotating, the flywheels, due to the rotational inertia thereof, convert the stored potential energy into kinetic energy for the transmission shaft to keep rotating.

The first power output shaft has a first driving gear fixedly mounted thereon, and the second power output shaft has a second driving gear fixedly mounted thereon. The first and second driving gears mesh with the transmission gear mounted on the transmission shaft, and are bilaterally symmetrically located at two lateral sides of the transmission gear.

The first driving gear has a fixed first curved boss eccentrically provided thereon to protrude from a side surface thereof, and the second driving gear has a fixed second curved boss eccentrically provided thereon to protrude from a side surface thereof. The second curved boss on the second driving gear and the first curved boss on the first driving gear are identical in shape and size, and are bilaterally symmetrical in position.

The transmission shaft has a third flywheel mounted thereon to further upgrade the energy storing function of the transmission mechanism.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a phantom view of an electrically powered generator according to a preferred embodiment of the present invention; and

FIG. 2 is a top plan view of FIG. 1.

### DETAILED DESCRIPTION OF THE PREFERRED EMBODIMENTS

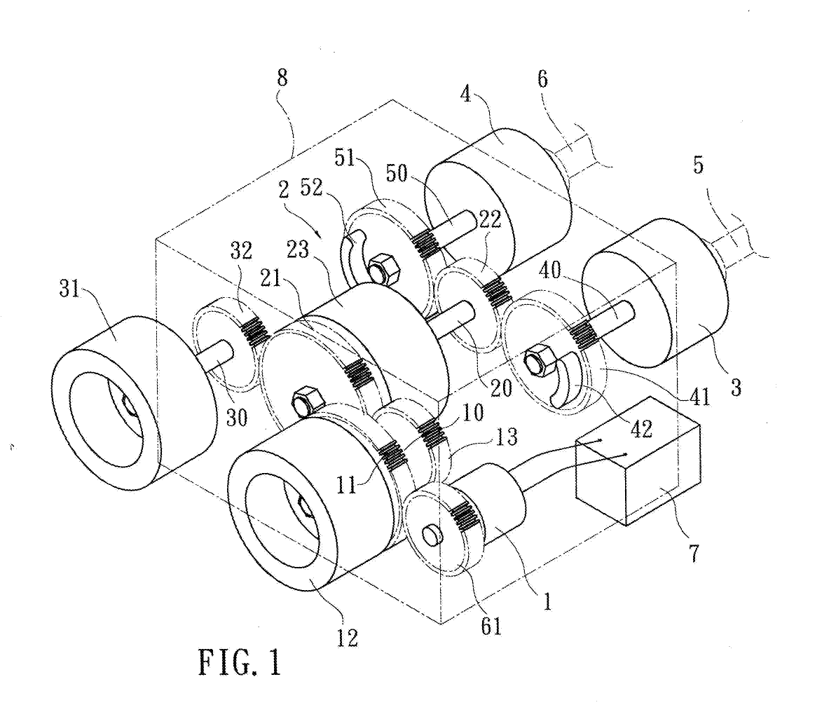

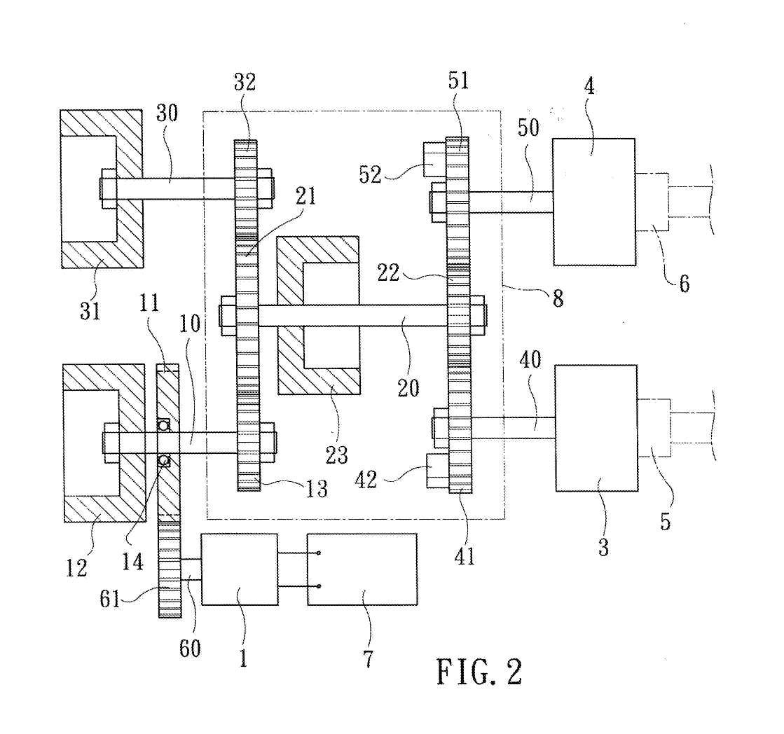

Please refer to FIGS. 1 and 2. An electrically powered generator according to the present invention uses an electric motor 1 as its power source to drive a transmission mechanism 2. First and second rotors 3, 4 are connected to a rear end of the transmission mechanism 2 to cooperate with proper stators 5, 6 for the latter to output induced electrical energy. Electric current needed by the electric motor 1 to operate is supplied by a battery device 7, which is in turn charged by a part of the electrical energy generated by the present invention. The electric motor 1 has an output rotational speed of 5000 rpm. Preferably, the first and second rotors 3, 4 connected to the rear end of the transmission mechanism 2 have a rotational speed ranged between 290 and 300 rpm. In FIGS. 1 and 2, reference numeral 8 denotes a housing for the transmission mechanism 2.

The transmission mechanism 2 includes a drive shaft 10, a transmission shaft 20, an auxiliary power shaft 30, a first power output shaft 40, and a second power output shaft 50. The drive shaft 10 is driven by the electric motor 1 to rotate, and is able to transmit its rotational power to the transmission shaft 20 and bring the latter to rotate. The transmission shaft 20 is able to transmit its rotational power to the auxiliary power shaft 30, the first power output shaft 40 and the second power output shaft 50 at the same time.

The drive shaft 10 has a unidirectional transmission gear 11, a first flywheel 12, a first power output gear 13 mounted thereon. The electric motor 1 has a power output shaft 60, on which a gear 61 is fixedly mounted for meshing with the unidirectional transmission gear 11. With this arrangement, the electric motor 1 can transmit its rotational power to the unidirectional transmission gear 11 for the latter to rotate. A unidirectional transmission bearing 14 is mounted between the unidirectional transmission gear 11 and the drive shaft 10, so that the unidirectional transmission gear 11 can bring the drive shaft 10 to rotate while the drive shaft 10 cannot bring the unidirectional transmission gear 11 to rotate. With this arrangement, it is able to prevent the power output shaft 60 of the electric motor 1 from rotating due to any reverse transmission. The first flywheel 12 and the first power output gear 13 are fixedly mounted on the drive shaft 10 to rotate along with the drive shaft 10 as an integral body. The electric motor 1 stops operating when the drive shaft 10 reaches a rotational speed of 2500 rpm. However, the electric motor 1 will resume operation as soon as the drive shaft 10 has a rotational speed less than 2400 rpm, so as to increase the rotational speed of the drive shaft 10 to 2500 rpm again.

The transmission shaft 20 has a reduction gear 21 and a transmission gear 22 fixedly mounted thereon. The reduction gear 21 meshes with the first power output gear 13 mounted on the drive shaft 10.

The auxiliary power shaft 30 has a second flywheel 31 and a second power output gear 32 fixedly mounted thereon. The second power output gear 32 meshes with the reduction gear 21 on the transmission shaft 20, and is the same as the first power output gear 13 in size. The above arrangement enables the auxiliary power shaft 30 and the drive shaft 10 to rotate synchronously. The auxiliary power shaft 30 and the drive shaft 10 are bilaterally symmetrically located at two lateral sides of the transmission shaft 20; and the first flywheel 12 and the second flywheel 31 are identical in shape and weight.

The first power output shaft 40 has a first driving gear 41 and the first rotor 3 fixedly mounted thereon. The first driving gear 41 meshes with the transmission gear 22 on the transmission shaft 20, enabling the transmission shaft 20 to transmit its rotational power to the first power output shaft 40 and rotate the latter accordingly. On the first driving gear 41, a fixed first curved boss 42 is eccentrically provided to protrude from a side surface of the first driving gear 41. In practical implementation of the present invention, the first power output shaft 40 preferably has a rotational speed ranged between 290 and 300 rpm.

The second power output shaft 50 has a second driving gear 51 and the second rotor 4 fixedly mounted thereon. The second driving gear 51 meshes with the transmission gear 22 on the transmission shaft 20, enabling the transmission shaft 20 to transmit its rotational power to the second power output shaft 50 and rotate the latter accordingly. The second power output shaft 50 and the first power output shaft 40 rotate synchronously. On the second driving gear 51, a fixed second curved boss 52 is eccentrically provided to protrude from a side surface of the second driving gear 51. The second curved boss 52 and the first curved boss 42 are identical in shape and size. The second power output shaft 50 and the first power output shaft 40 are bilaterally symmetrically located at two lateral sides of the transmission shaft 20; and the first curved boss 42 on the first driving gear 41 and the second curved boss 52 on the second driving gear 51 are bilaterally symmetrical in position. Since the second power output shaft 50 and the first power output shaft 40 rotate synchronously, the first curved boss 42 on the first driving gear 41 and the second curved boss 52 on the second driving gear 51 are always bilaterally symmetrical in position with respect to the transmission shaft 20.

The electric motor 1 stops outputting power when the drive shaft 10 is driven by it to rotate at a rotational speed of 2500 rpm. At this point, the first flywheel 12 mounted on the drive shaft 10 and the second flywheel 31 mounted on the auxiliary power shaft 30 have already stored potential energy in them. At the time the electric motor 1 stops operating, the first flywheel 12 and the second flywheel 31, due to their rotational inertia, convert the stored potential energy into kinetic energy, which brings the drive shaft 10 and the auxiliary power shaft 30 to keep rotating and outputting power. Since the rotation of the drive shaft 10 does not bring the unidirectional transmission gear 11 to rotate, the power output shaft 60 of the electric motor 1 would not rotate due to any reverse transmission of the drive shaft 10. In other words, the transmission mechanism 2 can maintain normal operation and keep generating electric energy when the battery device 7 does not supply electric current to the electric motor 1. Therefore, the electrically powered generator according to the present invention can naturally have upgraded kinetic-to-electric energy conversion efficiency.

The drive shaft 10 and the auxiliary power shaft 30 are arranged at two lateral sides of the transmission shaft 20. Further, the first flywheel 12 and the first power output gear 13 mounted on the drive shaft 10 are respectively identical to the second flywheel 31 and the second power output gear 32 mounted on the auxiliary power shaft 30. Therefore, the drive shaft 10 and the auxiliary power shaft 30 can simultaneously output equal power when the first flywheel 12 and the second flywheel 31 release their stored potential energy to rotate the drive shaft 10 and the auxiliary power shafts 30, respectively. This arrangement can produce balanced power at two lateral sides of the transmission shaft 20, enabling the transmission shaft 20 to rotate more evenly and stably.

The first curved boss 42 on the first driving gear 41 mounted on the first power output shaft 40 and the second curved boss 52 on the second driving gear 51 mounted on the second power output shaft 50 function to accelerate the rotation of the first power output shaft 40 and the second power output shaft 50, respectively. As a result, the first and the second power output shaft 40, 50 can maintain the preset rotational speed longer when the electric motor 1 is not in operation and further upgrade the generating efficiency of the electrically powered generator of the present invention.

The highest rotational speed set for the first power output shaft 40 and the second power output shaft 50 is 300 rpm, which is a low-speed rotation. The transmission gear 22 mounted on the transmission shaft 20, the first driving gear 41 mounted on the first power output shaft 40, and the second driving gear 51 mounted on the second power output shaft 50 rotate simultaneously, and the first and the second driving gear 41, 51 rotate synchronously, enabling the transmission gear 22, the first driving gear 41 and the second driving gear 51 to work in a stable manner without producing vibrations.

In practical implementation of the present invention, the transmission shaft 20 further has a third flywheel 23 mounted thereon. The third flywheel 23 also has the function of storing potential energy. At the time the electric motor 1 stops operating, the third flywheel 23, due to its rotational inertia, converts the stored potential energy into kinetic energy, which serves as a power for the transmission shaft 20 to rotate continuously.

In summary, in the electrically powered generator according to the present invention, since the first, second and third flywheels 12, 31, 23 have the potential energy storing function and can convert the stored potential energy into kinetic energy due to their rotational inertia, the entire transmission mechanism 2 can keep operating and maintain the generation and output of electric energy while the electric motor 1 stops operating. With these arrangements, the electrically powered generator of the present invention can have upgraded generating efficiency.

The present invention has been described with a preferred embodiment thereof and it is understood that many changes and modifications in the described embodiment can be carried out without departing from the scope and the spirit of the invention that is intended to be limited only by the appended claims.

What is claimed is:

1. An electrically powered generator, comprising an electric motor having an output rotational speed of 5000 rpm, a transmission mechanism driven by the electric motor to operate, and stators connected to a rear end of the transmission mechanism, characterized in that the transmission mechanism includes:
a drive shaft driven by the electric motor to rotate, and having a unidirectional transmission gear, a first flywheel and a first power output gear mounted thereon; the unidirectional transmission gear being driven by the electric motor to rotate; a unidirectional transmission bearing being mounted between the unidirectional transmission gear and the drive shaft, such that the unidirectional transmission gear can bring the drive shaft to rotate but the drive shaft could not bring the unidirectional transmission gear to rotate; the electric motor stopping operating when the drive shaft reaches a rotational speed of 2500 rpm; and the electric motor resuming operation when the drive shaft has a rotational speed less than 2400 rpm;
a transmission shaft having a reduction gear and a transmission gear fixedly mounted thereon; and the reduction gear meshing with the first power output gear mounted on the drive shaft;
an auxiliary power shaft having a second flywheel and a second power output gear fixedly mounted thereon; the second power output gear meshing with the reduction gear mounted on the transmission shaft and rotate synchronously with the drive shaft; and the auxiliary power shaft and the drive shaft being bilaterally symmetrically located at two lateral sides of the transmission shaft;
a first power output shaft having a first driving gear and a first rotor fixedly mounted thereon; the first driving gear meshing with the transmission gear mounted on the transmission shaft; the first driving gear having a fixed first curved boss eccentrically provided thereon to protrude from a side surface thereof; and the first power output shaft having a rotational speed ranged between 290 and 300 rpm; and
a second power output shaft having a second driving gear and a second rotor fixedly mounted thereon; the second driving gear meshing with the transmission gear mounted on the transmission shaft, and the second power output shaft and the first power output shaft rotating synchronously; the second driving gear having a fixed second curved boss eccentrically provided thereon to protrude from a side surface thereof; the second power output shaft and the first power output shaft being bilaterally symmetrically located at two lateral sides of the transmission shaft; and the second curved boss on the second driving gear and the first curved boss on the first driving gear being identical in shape and size, and being bilaterally symmetrical in position.

2. The electrically powered generator as claimed in claim 1, wherein the transmission shaft has a third flywheel mounted thereon.
